(19) United States
(12) Patent Application Publication
(10) Pub. No.: US 2012/0049610 A1
(43) Pub. Date: Mar. 1, 2012

(54) Rim Wear Indicator

(75) Inventor: Paul Lew, Las Vegas, NV (US)

(73) Assignee: REYNOLDS CYCLING LLC, West Jordan, UT (US)

(21) Appl. No.: 12/871,757

(22) Filed: Aug. 30, 2010

(51) Int. Cl. B60B 21/08

(52) U.S. Cl. 301/95.103

(57) ABSTRACT

A wheel rim for a human powered vehicle includes a rim with a braking surface and a wear indicator located beneath the braking surface, such that when the braking surface is worn away, the wear indicator is visually exposed. A method for determining if a predetermined amount of rim wear has occurred in a rim braking human powered vehicle is also provided.

### BACKGROUND

Human powered vehicles are used for transportation and recreation around the world. Braking for these vehicles can be implemented in a number of ways, including rim brakes. Rim brakes are friction pads which are compressed against the rims of the wheels. The friction between the pads and the rims gradually wears away both the pads and the rims. Excessive rim wear can weaken the rim and lead to mechanical failure of the wheel.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1A is a diagram of an illustrative bicycle wheel, according to one example of principles described herein.

FIGS. 1B and 1D are diagrams of illustrative rim cross sections, according to one example of principles described herein.

FIG. 2 is a cross sectional diagram of a bicycle wheel with rim brakes, according to one example of principles described herein.

FIGS. 3A and 3B are cross sectional diagrams of a portion of a composite wheel rim with an embedded rim wear indicator, according to one example of principles described herein.

FIGS. 4A-4D are diagrams of illustrative rim wear indicators, according to one example of principles described herein.

FIG. 5A and 5B are diagrams of a wear indicator with multiple indicator elements, according to one example of principles described herein.

FIG. 6 is a cross sectional diagram of a combined wear indicator, according to one example of principles described herein.

FIG. 7A and 7B are diagrams of a wear indicator which has a visible portion, according to one example of principles described herein.

Throughout the drawings, identical reference numbers designate similar, but not necessarily identical, elements.

### DETAILED DESCRIPTION

Rim braking for bicycles or other human powered wheeled vehicles use friction pads which are compressed against the rims of the wheels. Rim braking provides a number of advantages, including generating large braking forces with minimal actuator force, low part count, reliability, and low weight. As discussed above, the friction between the pads and the rims gradually wears away both the pads and the rims. Aggressive braking and braking in dusty or wet environments can significantly accelerate this wear.

Excessive rim wear can weaken the rim and lead to mechanical failure of the bicycle wheel. Even through rim wear is a normal occurrence, there is no obvious visual indication of when the wear has excessively weakened the rims. Consequently, riders may not be aware that the wheel has been structurally compromised and may experience wheel failures due to the excessive rim wear.

This specification is directed toward wear indicators embedded in the rim which clearly indicate the wear status of the rim. As rim wear occurs, the wear indicators are exposed, allowing for quick and accurate rim wear. These wear indicators may take a number of forms, including visual indicators and tactile indicators. Visual indicators are visually distinct from the surrounding rim material and easily identified when exposed. Tactile indicators have different frictional characteristics than the surrounding material and, when exposed, produce tactile feedback to the rider during braking. A particular wear indicator may be a visual indicator, a tactile indicator, or a combination of both a visual indicator and a tactile indicator.

There may be one or more indicators on rims on both sides of the wheel. In some examples, the indicator for a particular rim may be located in a designated location on the rim. In other examples, a plurality of indicators may be distributed around the rim. A number of indicators may be layered on top of each other, with the indicators providing progressive warnings of rim wear. In one embodiment, the wear indicator has a visible portion and a hidden portion when the rim is manufactured. The visible portion of the wear indicator clearly shows the location, color and size of the hidden portion. This allows wheels which include a wear indicator to be easily identified and simplifies checking the rims for wear.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

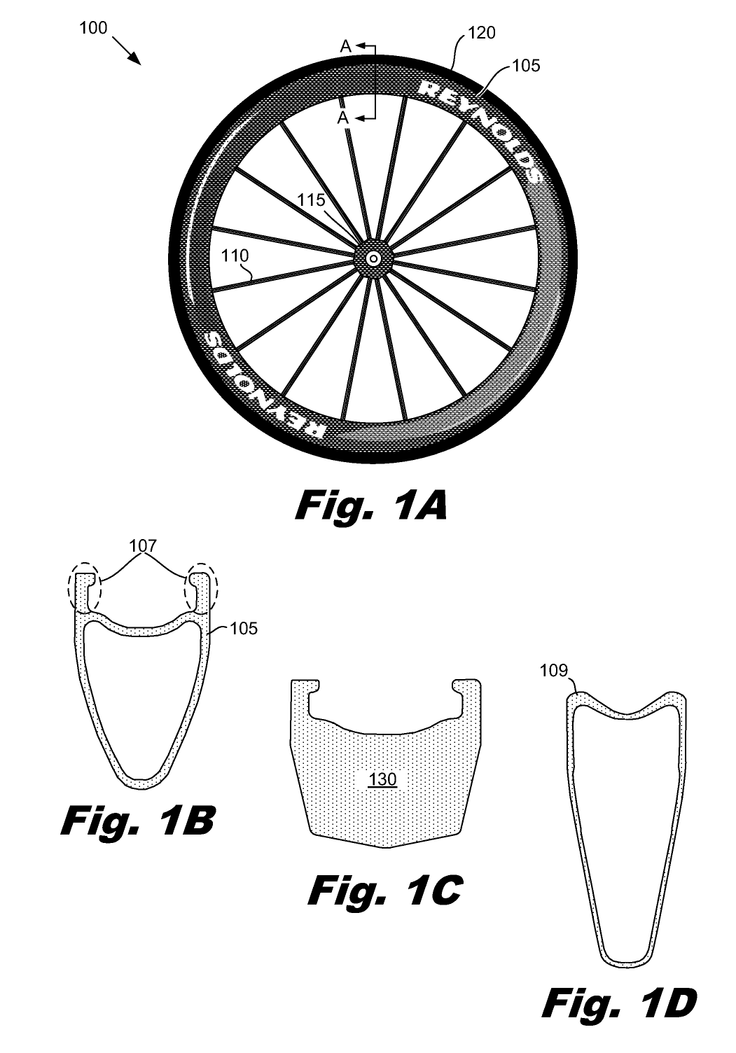

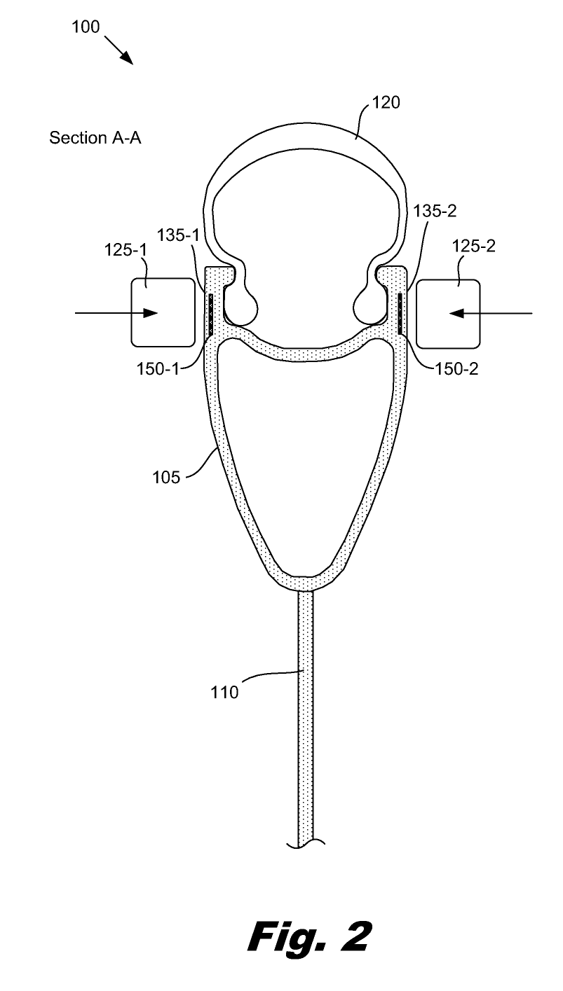

FIG. 1A is a diagram of an illustrative bicycle wheel (100). In this example, the bicycle wheel (100) is a composite racing wheel which has been designed to have very low mass and high performance characteristics. The wheel includes a carbon composite rim (105), a number of composite spokes (110), a hub (115) and a tire (120).

Although the rim (105) illustrated in FIG. 1A is a carbon composite bicycle rim, the principles and wear indicators described below can be broadly applied to human powered vehicles which utilize rim braking. For example, the wear indicators may be used on wheel chairs, three and four wheel vehicles, bicycles, scooters, or other vehicles. These vehicles may have injection molded bicycle rims, composite rims, aluminum rims, steel rims or other types of rims.

FIGS. 1B-1D show illustrative rim cross sections. FIG. 1B is a cross section of an illustrative composite clincher rim (105). Composite rims may be used in applications where weight, rotational inertia, aerodynamics, and stiffness are significant considerations. For example, composite rims are used in road cycling races such as the Tour de France and Giro D'Italia. Composite rims can be significantly more time consuming to construct and, consequently, can be more expensive than metal or reinforced plastic rims.

The rim (105) has two bearing structures (107) which extend radially outward from the body of the rim. These bearing structures serve both as braking surfaces and to retain the tire. To lighten the wheel and maintain the desired performance, these bearing structures (107) are specifically tailored to have just enough material to withstand the expected brake wear, loads of the inflated tire, and dynamic cycling forces. Because the bearing structures (107) do not contain a significant amount of excessive material, rim wear caused by braking must be watched carefully. Excessive wear of the braking surfaces can result in the rim (105) suddenly collapsing in situations which require hard braking.

FIG. 1C shows a cross section of an illustrative fiber reinforced plastic rim (130) which has a solid interior. The plastic rim (130) can be injection molded and, consequently, can be produced at significantly lower cost. The plastic rim (130) is used in applications where cost is a driving factor and weight and aerodynamics are less important. While the plastic rim (130) has a significantly larger cross section than the composite rim (105), it is still important to detect rim wear before the structural integrity of the rim is compromised.

FIG. 1D shows a cross section of an illustrative composite tubular rim (109). Tubular rims (109) do not have bearing structures to retain the tire. Instead, the tubular rims (109) are designed to have tires glued to their outer perimeters. Consequently, the tubular rims (109) can be lighter than other types of rims.

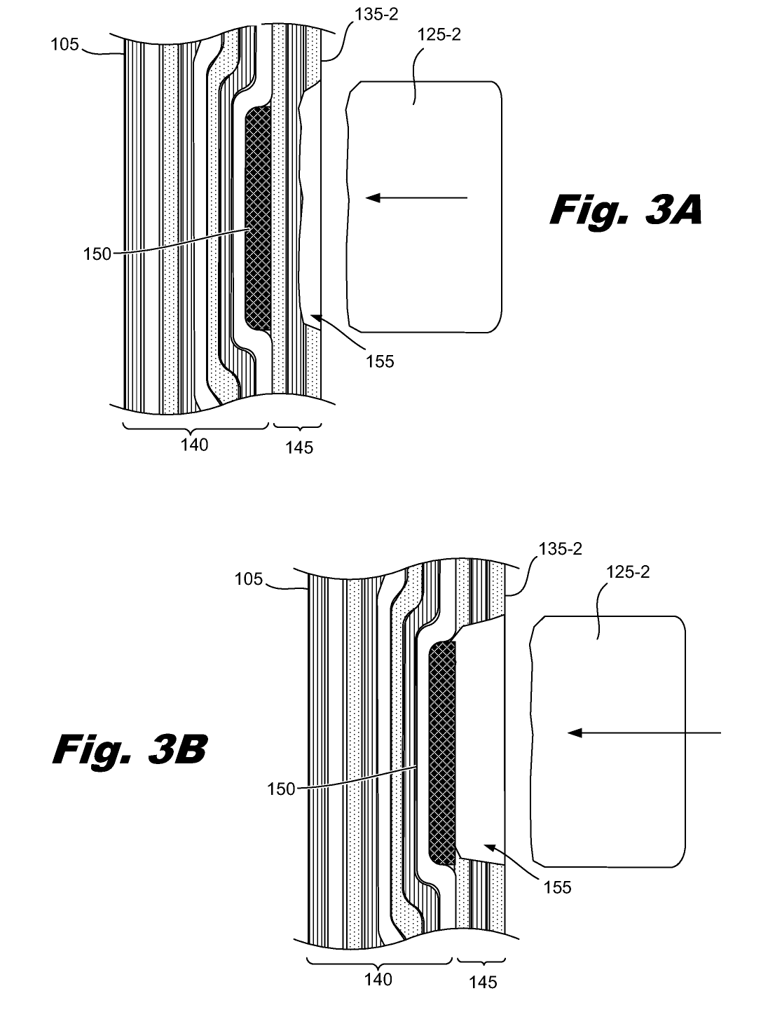

FIG. 2 is a cross sectional diagram the bicycle wheel (100) illustrated in FIG. 1A along section line A-A. As discussed above, the wheel (100) includes a rim (105), spokes (110), and a tire (120) which is fitted to the rim (105). During use, rim braking can slow or stop the rotation of the wheel (100). Rim braking involves pressing two pads (125) onto opposing braking surfaces (135) as shown by the arrows. The two friction pads (125) pinch the rim (105) between them. This generates friction which slows the rotation of the wheel (100) and dissipates the energy as heat. The repeated rim braking results in normal and expected removal of material from both the pads (125) and the rim (105). Under typical riding conditions, the rate of material removal is relatively slow. For example, a rider may travel several years and thousands of miles before the rim wear becomes excessive. However, aggressive braking in contaminated environments can significantly increase the material removal rate. If a rider travels on wet surfaces, water from the road may splash onto the wheel (100) and braking surfaces (135). The water deposits contaminants, such as sand or grit, on the braking surfaces (135) and friction pads (125). When the brakes are applied, the sand abrades the braking surfaces and accelerates the material removal from both the pads (125) and the rim (105).

Currently riders use a number of inexact, expensive and/or cumbersome methods to mitigate the risks of rim wear. For example, a rider may simply feel the groove formed by tire wear with a finger and guess at the amount of wear which has occurred. A more exacting rider may lay a straight edge along the side of the rim (105) and attempt to measure the depth of the groove. Additionally or alternatively, the rider or technician may dismount the tire (120) and use a micrometer to measure the thickness of rim (105). Some teams or riders may replace the rims (105) according to a fixed formula to avoid any chance of excessive rim wear. This approach can be expensive because rims (105) will typically be replaced long before brake wear begins to become a reliability issue.

This specification is directed toward wear indicators (150) embedded in the rim (105) which clearly indicate the wear status of the rim. As rim wear occurs, the wear indicators (150) are exposed, allowing for quick and accurate assessment of the rim wear. The wear indicators (150) are located at a designed depth beneath the braking surfaces (135). The amount of material which overlays the wear indicators (150) is designed to be removed by rim braking without compromising the function of the rim (105).

The wear indictors (150) are located on both sides of the rim (105). For a variety of reasons, the rim wear is often greater on one side of the rim (105) than the other. Consequently, the rim wear indicators (150) are located on both sides of the rim (105) to allow for detection of uneven rim wear and to alert the rider if either side of the rim (105) has been worn down excessively.

These wear indicators (150) may take a number of forms, including visual indicators and tactile indicators. Visual indicators are visually distinct from the surrounding rim material and easily identified when exposed. Tactile indicators have different frictional characteristics than the surrounding material and, when exposed, product tactile feedback to the rider during braking. A particular wear indicator (150) may be a visual indicator, a tactile indicator, or a combination of both a visual indicator and a tactile indicator.

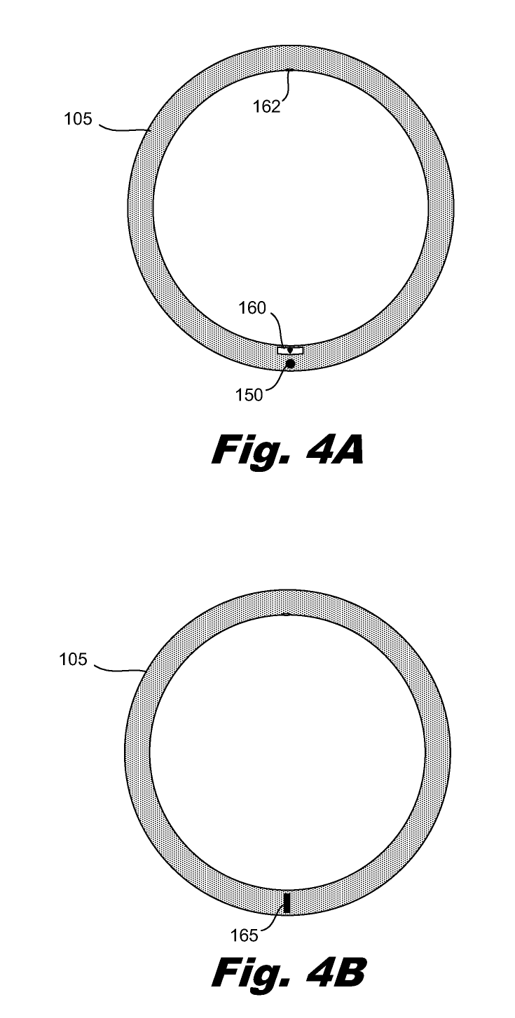

FIGS. 3A and 3B are cross sectional diagrams of a rim (105) which includes an embedded rim wear indicator (150) which accurately and visually indicates when a designed level of rim wear has been reached. FIG. 3A illustrates the embedded wear indicator (150) sandwiched between two groups composite layers (140, 145). A first group (140) has been designed with sufficient layers to withstand the forces of an inflated tire (120, FIG. 2) and forces generated during cycling. The second group (145) has been designed to be sacrificial layers which will be worn away at the braking surfaces (135-2). The layers in the first and second groups (140, 145) may be formed from the same or different composite materials. For example, both groups (140, 145) may be formed from the same carbon fibers and resin system. Alternatively, the first group (140) may be engineered for abrasion and/or heat resistance while the second group (145) is engineered from strength. The first group (140) may have a different resin system, resin additives, or different fibers. In this example, the first group (140) has three plies and may be between 0.005 and 0.025 inches thick. The first group (140) has eight plies. Depending on the application, the first and second groups may have any number of plies or thickness. For example, where the rim (105) is injection molded, the thickness of the material may be significantly higher.

As discussed above, where the fiction pad (125-2) contacts the braking surface (135-2), material is worn away to form a groove (155). In FIG. 3A, the groove (155) is about one and a half plies deep. At this point, the rim wear has not compromised the designed strength of rim (105) and the rim wear indicator is not visible.

In FIG. 3B, additional braking has increased the depth of the groove (155) through the three plies in the second group (145). The rim wear indicator (150) is now visible in the bottom of the groove. The rim wear indicator (150) could be formed from a variety of materials, including fabric, polymers, metals, or other materials. According to one embodiment, the rim wear indicator (150) could be made from a variety of materials which visually contrast with the surrounding layers. For example, if the rim (105) is formed from carbon composite which has a black color, the rim wear indicator (150) could be red, yellow, white, or other color which contrasts with the black carbon composite. Additionally or alternatively, the rim wear indicator (150) could be formed from a material which has different surface characteristics than the surrounding material. This will cause uneven friction as the pad (125) presses on the rim (105) and will provide tactile feedback to the rider during braking.

When the wear indicator (150) becomes visible to the rider, the rider is alerted that the rim (105) is reaching the end of its life. Ideally, the rim wear indicator (150) would give the rider a reasonable amount of notice prior to the rim wear creating a hazardous situation. The rider, upon seeing the wear indicator for the first time, would then have time to finish a ride, order another rim, or switch the rim for a replacement rim.

According to one illustrative embodiment, the wear indicator may be a non-ply material. As used in the specification and appended claims, the term “non-ply material” is a material different than structural plies which make up the bicycle rim. For example, a non-ply material may be a cotton fabric. Cotton fabric has a number of advantages, including readily absorbing a variety of dyes, being compatible with the carbon fiber manufacturing process, and readily absorbing resin and adhering to the carbon plies. Additionally, resin impregnated cotton fabrics exhibit substantially the same coefficient of friction as the carbon fiber. Consequently, the adverse effects on braking when the rim wear indicator (150) is exposed are minimal. Specifically, the brakes do not chatter or grab when rim wear indicator (150) is exposed. The cotton fabrics may have a variety of thicknesses. For example, the cotton fabric may have a thickness of approximately 0.015 inches. The thickness of the cotton fabric provides the rider with a substantial period of time during which the rim wear indicator (150) is visible.

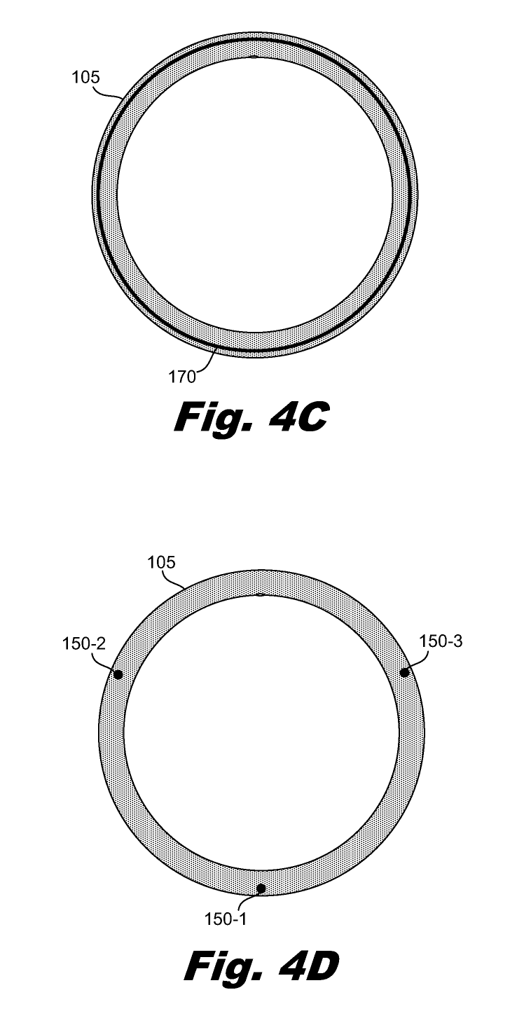

FIGS. 4A-4D are diagrams which show the shape of the rim wear indicators and their location around the rim. In FIG. 4A, the rim wear indicator (150) is a circular disk which is embedded under several plies of unidirectional carbon fiber. For purposes of illustration, the rim wear indicator (150) is shown as a black disk. However, in practice this embodiment of the rim wear indicator (150) is not visible on the rim (105) when it is initially manufactured because the rim wear indicator (150) is embedded beneath several plies of black carbon fiber. To aid the rider in indentifying the position of the wear indicator (150) several techniques may be used. In one technique, a sticker or other adhesive label (160) is placed on the rim (105) in a location outside the brake wear surface (135, FIG. 2). The label (160) has an arrow or other indicator which points to the embedded rim wear indicator (150). Additionally or alternatively, the rim wear indicator (150) may be positioned with reference to a known location on the rim (105). For example, the rim wear indicator (150) may be located opposite a valve stem hole (162).

FIG. 4B shows an alternative rim wear indicator (165). In this embodiment, the rim wear indicator (165) is a strip which crosses a substantial portion of the rim (105), including the brake wear surface.

FIG. 4C shows a rim wear indicator (170) which takes the form of circular strip around the entire circumference of the rim (105). At least a portion of the rim wear indicator (170) is located beneath the braking surface (135-2) of the rim (105). This type of rim wear indicator may have a number of advantages. For example, because the rim wear indicator (170) may underlie the entire circumference of the braking surface, irregularities or misalignments in the braking system or bicycle will be readily apparent if one portion of the rim wear indicator (170) becomes visible before other portions. Another advantage may be that the rim wear indicator (170) does not form discontinuities in the wall of the rim (105). Instead, all cross sections of the bearing structures have identical cross sections. This may simplify the design, testing and manufacturing of the rim (105).

FIG. 4D shows a number of circular rim wear indicators (150) which are located at multiple locations around the rim. This configuration may provide many of the same benefits as the continuous rim wear indicator (170) described above. For example, the distribution of rim wear indicators (150) around the rim (105) allows for uneven rim wear to be detected. As discussed above, stickers or other markers could be used to show the location of the rim wear indicators (150). The multiple rim wear indicators (150) may also provide redundancy and have a greater visual effect than a single pair of rim wear indicators (150) embedded at one location on the rim (105).

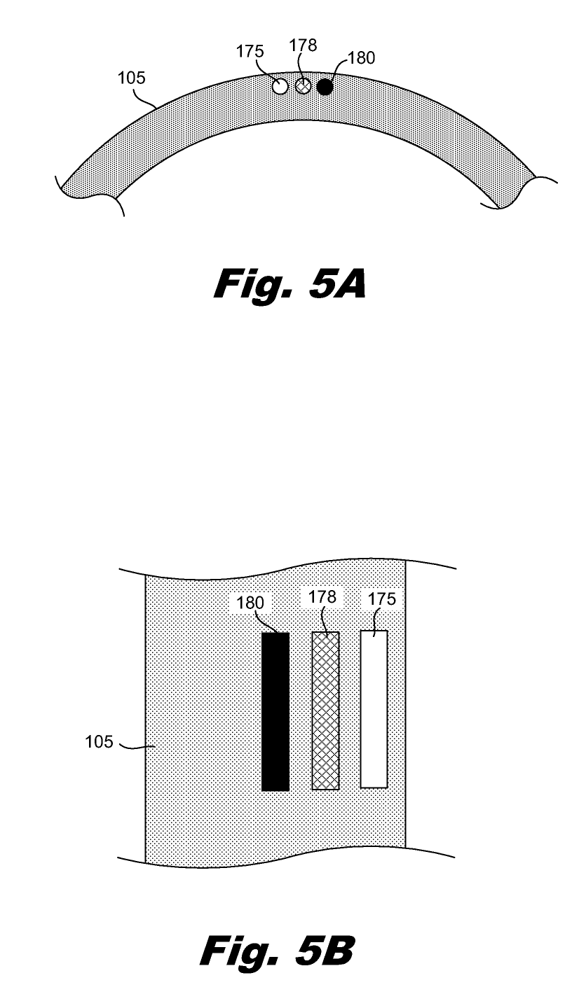

FIGS. 5A and 5B show a rim (105) with multiple rim wear indicator elements (175, 178, 180). The multiple rim wear indicator elements (175, 178, 180) may provide progressive wear information to a rider or technician. In this embodiment, there are three different circular disks, each having a different color and being embedded at different depths from the brake wear surface (135, FIG. 2). For example, a first white rim wear indicator (175) may be located beneath one ply of carbon fiber. Consequently, when the rider wears through the first carbon layer, only the white rim wear indicator (175) may be visible. At this point, the rider knows that the rim is safe to ride and that the rider has used approximately one third to one fourth of the total depth available.

As the rider continues to brake, the first indicator (175) will be worn away and the second rim wear indicator (178) will be exposed. This wear indicator (178) may be a different color, such as yellow. Upon seeing the yellow wear indicator, the rider is aware that they have used one half to two thirds of the available wear surface. The third wear indicator (180) is exposed by further braking and indicates that the maximum wear on the rim (105) has occurred and continued use of the rim (105) may potentially be hazardous. The rider has had ample opportunity at this point to plan for and obtain a new rim (105) to replace the worn out rim (105).

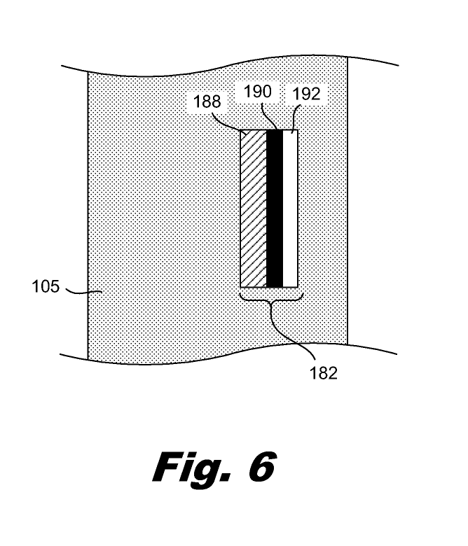

FIG. 6 is a cross sectional diagram of a combined wear indicator (182) which includes two visual wear indicators (190, 192) and one tactile wear indicator (188). The combined wear indicator (182) is a single unit which is embedded into the braking surfaces of the rim. As discussed above, a number of combined wear indicators (182) may be placed on both sides of the rim (105) and at multiple locations around the rim (105). As the friction pad (125, FIG. 2) wears away the braking surface (135, FIG. 2), the first visual wear indicator (192) and then the second visual wear indicator (190) are sequentially exposed. For example, the first visual wear indicator (192) may be a yellow warning color and the second visual wear indicator (190) may be a red color. When the second visual indicator (190) is exposed it signals the rider to replace the rim (105).

If the rider does not replace the (105) rim in a timely fashion, the friction pad (125, FIG. 2) eventually wears away the second visual indicator (190) and exposes the tactile wear indicator (188). The tactile wear indicator (188) has different friction characteristics than the surrounding rim material. Consequently, as the rider applies the brakes with a manual actuator, the manual actuator and/or tire will vibrate each time the friction pads pass over the tactile wear indicator (188). Although this may slightly decrease the braking power and/or control of the bike, the wear is serious enough that the rim (105) must be promptly replaced to prevent failure of the rim (105).

The tactile wear indicator (188) may be formed from a number of materials which have frictional characteristics which are different than the surrounding material. For a given braking system, many metals and some polymers may have lower coefficients of friction than carbon fiber. For example, steel, titanium, polytetrafluoroethylene (PTFE), and other materials may have coefficients of friction which are lower than carbon fiber for a given type of brake pad. Similarly, materials may be selected which have higher coefficients of friction than the surrounding rim material.

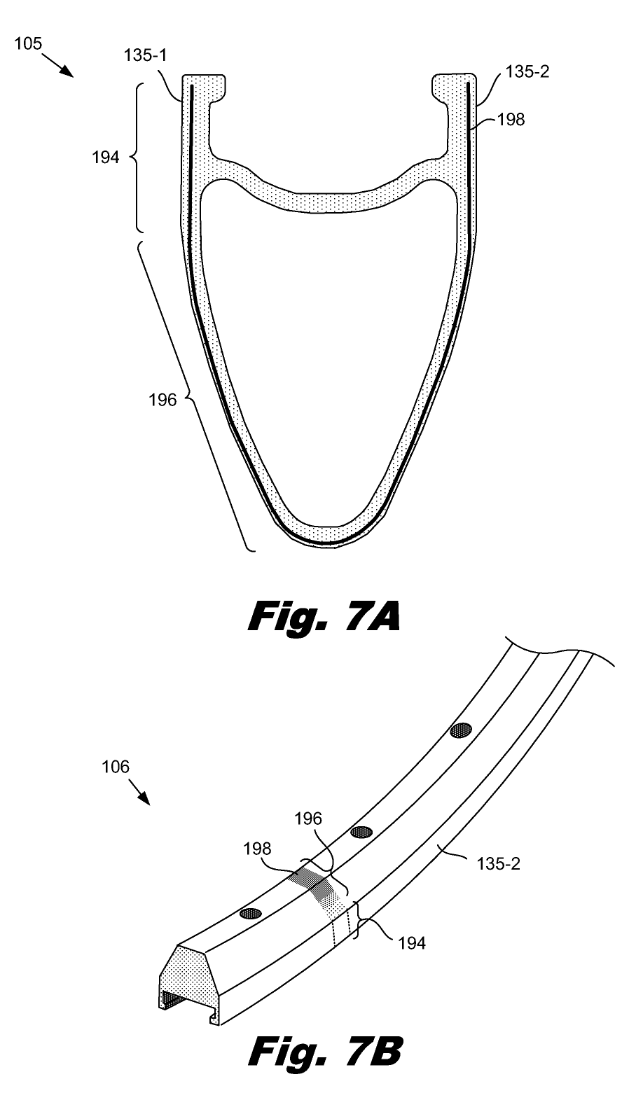

FIGS. 7A and 7B are diagrams of a wear indicator (198) which has a visible portion (196) and a hidden embedded portion (194). FIG. 7A is a cross sectional diagram of a composite rim (105). The hidden embedded portion (194) of the wear indicator (198) is buried under multiple plies of carbon composite which form the braking surface (135). The hidden embedded portion (194) is not visible until the significant brake wear has occurred on the braking surface (135). However, wear indicator (198) extends beyond the braking surface (135) and around the rim. As the wear indicator (198) moves away from the braking surface, there are progressively fewer overlying plies. This allows the wear indicator to be visible to the user. For example, the wear indicator may be covered by only a ply of woven carbon fibers. After being cured, the wear indicator is partially visible through the woven carbon fibers. In other embodiments, the visible portion of the wear indicator may not be covered by any plies, but may form the outmost layer by itself.

FIG. 7B shows a section of a rim (106) in which a wear indicator (198) is in the “as manufactured” state. The wear indicator (198) passes from the braking surfaces (135) over the top of the rim. The hidden embedded portions (194) are under the braking surfaces (135-2) on the sides of the rim (106) and the visible portion (196) is on the top surface of the rim (106). The visible portion (196) of the wear indicator (198) provides a rider or technician with positive identification of the color, location, and type of the wear indicator (198). Further, the visible portion (196) can be compared to any part of the embedded portion (194) which is visible after brake wear occurs. This allows for quick and accurate verification of the rim wear.

The examples given above are only illustrative embodiments. A number of variations and combinations of wear indicators could be used according to the principles described herein. For example, although single color visual wear indicators have been described, the visual wear indicators may have multiple colors and patterns. A visual wear indicator may include a number, flag, logo, or other information. Further, wear indicators may have a variety of shapes, sizes, surface textures or other characteristics. For example, wear indicators may be created by imbedding reflective, magnetic, ferrous, holographic, or colored particulates in a particular resin matrix. These particulates may be detected in a variety of ways, including reflection of visible light, black light, UV light, or infrared light. In one embodiment, a wear indicator may include an upper layer which contains magnetically shielding particulates and lower layer may include a magnetic material. As the upper layer is worn away by braking, the magnetic material become increasingly exposed. A Hall effect sensor or other device could then detect the magnetic field.

Other embodiments may include optical fibers which have optically exposed portions away from the braking surface which collect ambient light and buried portions in the braking surface. As braking wear cuts through the buried portions of the optical fibers, the concentrated ambient light escapes from the end of the buried fiber. This effect is particularly effective in full sunlight, but could also be detected by illuminating the wheel with artificial light. In another embodiment, the optical fiber could be placed beneath one or more plies of composite with both ends of the fiber terminating at known locations on the rim away from the braking surface. To sense rim wear, a first end of the optical fiber is illuminated. If the optical fiber conducts this light around the rim to the second end, the optical fiber has not been severed and the plies underlying the optical fiber have not yet been damaged. However, if rim wear has severed the optical fiber, the input light will not be conducted to the second end. A plurality of optical fibers could be embedded at various locations in the rim to give a more complete view of the rim condition. In some embodiments, the optical fibers may be colored or have coatings on the ends which allow the fibers to be more accurately identified and provide information the rim wear.

The wear indicators may be compared to a number of references which allow the rider to positively identify and correctly interpret the wear indicators. For example, duplicate wear indicators may be placed in the outer surface of the rim adjacent to the buried wear indicators. Alternatively, a sticker could be placed on the rim in proximity to the wear indicators. A manual may also describe the location and meaning of the various wear indicators included in a given rim.

In conclusion, the specification and figures describe a rim wear indicator which quickly and accurately alerts a rider or technician to a specified level of rim wear. The rim wear indicators provide the rider or technician with sufficient time to replace the rims prior to failure of the rim.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A wheel rim for a human powered vehicle comprises:
a composite rim with a braking surface;
a non-ply wear indicator located beneath the braking surface, such that when the braking surface is worn away, the wear indicator is exposed.

2. The rim of claim 1, in which rim comprises two braking surfaces on two opposing sides of the rim, one wear indicator being located beneath each braking surface.

3. The rim of claim 1, in which a color of the wear indicator contrasts with surrounding rim material.

4. The rim of claim 1, in which the wear indicator is a circle.

5. The rim of claim 1, in which the wear indicator is a radial strip.

6. The rim of claim 1, in which the wear indicator is a circumferential strip.

7. The rim of claim 1, further comprising a plurality of wear indicators located at multiple locations around braking surface.

8. The rim of claim 1, in which the wear indicator comprises multiple elements located at different depths beneath the braking surface.

9. The rim of claim 8, in which the wear indicator comprises a combined rim wear indicator having at least two different visual indicators, each having a different color.

10. The rim of claim 1, in which the rim wear indicator comprises a visual indicator and a tactile indicator, the tactile indicator having friction characteristics which are different from surrounding rim material such that a rider receives tactile feedback during braking.

11. The rim of claim 10, in which the tactile indicator is a metal which has a lower coefficient of friction than the surrounding rim material.

12. The rim of claim 10, in which the tactile indicator is a polymer material which has a higher coefficient of friction than the surrounding rim material.

13. The rim of claim 8, in which a plurality of separate wear indicators are embedded at various depths beneath the braking surface, wear indicators which are embedded at a common depth having a common color.

14. The rim of claim 1, in which at least a portion of the wear indicator, in an as manufactured state, is hidden under a braking surface and at least a portion of the wear indicator adjacent to the hidden portion is visible.

15. The rim of claim 14, in which a continuous section of the wear indicator is overlain by varying amounts of rim material, a first portion of the wear indicator being placed beneath the braking surface and initially overlaid with by sufficient rim material to completely hide first portion of the wear indicator until it is exposed by rim wear; a second portion of the wear indicator being overlaid with little or no rim material such that the second portion of the wear indicator is visible, in which the second portion of the rim wear indicator is not located on the brake wear surface.

16. The rim of claim 1, in which the rim is formed from carbon composite and the wear indicator is formed from dyed cotton fabric.

17. The rim of claim 1, in which the rim is formed from a plurality of plies, a first group plies underlying the visual indicator and having sufficient strength to maintain the integrity of the rim under design conditions; a second group of plies overlying the visual indicator are sacrificial layers which are worn away during braking to expose the visual indicator.

18. The rim of claim 1, in which the rim wear indicator comprises an optical fiber embedded beneath at least one composite ply of the rim, the optical fiber being configured to conduct light along a length of the optical fiber when the optical fiber and underlying composite plies are undamaged by rim wear; in which the optical fiber is configured to not transmit light along a length of optical fiber when rim wear has severed the optical fiber.

19. A brake wear indicator comprises a visual element embedded beneath a number of overlying plies in a braking area of a composite wheel rim, in which the visual element becomes exposed after the overlying plies are worn way by friction pads.

20. A method for determining if a predetermined amount of rim wear has occurred in a rim braking human powered vehicle comprises visually inspecting the rim to determine if a rim wear indicator which was embedded beneath the braking surface of a rim when the rim was manufactured has become exposed due to braking wear.
